(19) United States
(12) Patent Application Publication
(10) Pub. No.: US 2026/0189117 A1
(43) Pub. Date: Jul. 2, 2026

(54) ACTUATOR AND VIBRATION GENERATING DEVICE

(71) Applicant: FOSTER ELECTRIC COMPANY, LIMITED, Tokyo (JP)

(72) Inventors: Yuichi Morita, Akishima-shi, Tokyo (JP); Shinichiro Nagai, Akishima-shi, Tokyo (JP); Yoshikazu Okazaki, Akishima-shi, Tokyo (JP)

(21) Appl. No.: 19/127,970

(22) PCT Filed: Nov. 2, 2023
(86) PCT No.: PCT/JP2023/039752

§ 371 Date: May 7, 2025

(30) Foreign Application Priority Data
Nov. 8, 2022 (JP) 2022-178975

(51) Int. Cl. H02K 33/18

(52) U.S. Cl. CPC H02K 33/18

(57) ABSTRACT

A vibration generating device includes an actuator and a controller. The actuator includes an attachment member including a bottom wall portion, a coil that is fixed to the attachment member, and a movable element. The movable element is positioned at an origin position in a state in which current is not supplied to the coil, is displaced toward a bottom wall side due to current being supplied to the coil in one direction, and is displaced toward a side opposite to the bottom wall portion due to current being supplied to the coil in another direction. The controller controls supply of current to the coil such that a displacement amount of the movable element from the origin position toward the bottom wall portion side is less than a specified displacement amount, and repeatedly displaces the movable element with respect to the attachment member by switching the direction of current supplied to the coil. When the movable element is displaced toward the side opposite to the bottom wall portion, the movable element is displaceable so as to jut out from the attachment member.

### TECHNICAL FIELD

The present disclosure relates to an actuator and a vibration generating device.

### BACKGROUND ART

International Publication (WO) No. 2020/184439 discloses an actuator that includes an attachment member including a coil, and a movable element that is supported by the attachment member via an elastic support. Current is supplied to the coil described in this document via a cable. Further, when supply of current to the coil, via the cable, is switched, the movable element is repeatedly displaced (vibrates) with respect to the attachment member.

### SUMMARY OF THE INVENTION

### Technical Problem

Incidentally, in actuators that are configured such that a movable element is repeatedly displaced with respect to an attachment member, and vibration generating devices that are configured including such actuators, it is desirable to be able to reduce the body size of the actuator, and increase the amplitude of the movable element.

In consideration of the above-described circumstances, an object of the present disclosure is to obtain an actuator and a vibration generating device that are capable of reducing the body size of the actuator and increasing the amplitude of the movable element.

### Solution to Problem

An actuator of a first aspect includes: an attachment member including a bottom wall portion, the attachment member being open at a side opposite to the bottom wall portion; a coil disposed at an inner side of the attachment member, the coil being fixed to the attachment member; and a moveable element including a magnet disposed opposite to the coil, the moveable element being positioned at an origin position in a state in which current is not supplied to the coil, the moveable element displacing toward a bottom wall portion side due to current being supplied to the coil in one direction, and displacing toward the side opposite to the bottom wall portion due to current being supplied to the coil in another direction, wherein the moveable element is displaceable so as to jut out from the attachment member when the moveable element is displaced toward the side opposite to the bottom wall portion.

According to the actuator of the first aspect, the movable element is repeatedly displaced, with respect to the attachment member, toward the bottom wall portion side and the side opposite to the bottom wall portion. Note that, the movable element is capable of being displaced so as to jut out from the attachment member when displaced toward the side opposite to the bottom wall portion. This enables the body size of the actuator to be reduced, and enables the amplitude of the movable element to be increased.

In an actuator of a second aspect, in the actuator of the first aspect, a displacement amount of the moveable element toward the side opposite to the bottom wall portion is greater than a displacement amount of the moveable element toward the bottom wall portion side.

According to the actuator of the second aspect, the displacement amount of the movable element toward the side opposite to the bottom wall portion is greater than the displacement amount of the movable element toward the bottom wall portion side. This enables the amplitude of the movable element to be increased while suppressing contact of the movable element with the bottom wall portion of the attachment member.

In an actuator of a third aspect, in the actuator of the first aspect or the second aspect, a displaceable amount of an elastic support, a portion of which is fixed to the attachment member and another portion of which is fixed to the moveable element, toward the bottom wall portion side is greater than a distance between the moveable element and the bottom wall portion.

According to the actuator of the third aspect, the displaceable amount of the elastic support toward the bottom wall portion side is greater than the distance between the movable element and the bottom wall portion, such that the movable element can be made to have an amplitude, toward the side opposite to the bottom wall portion, which is greater than the distance between the movable element and the bottom wall portion. This enables the amplitude of the movable element to be increased while suppressing contact of the movable element with the bottom wall portion of the attachment member.

In an actuator of a fourth aspect, in the actuator of any one of the first aspect to the third aspect, an initial movement of the moveable element, when current is supplied to the coil, is displacement toward the bottom wall portion side.

According to the actuator of the fourth aspect, the initial movement of the movable element when current is supplied to the coil is displacement toward the bottom wall portion side, such that in a case in which short vibrations are generated in which vibrations of the movable element are amplified and damped, maximum displacement of the movable element occurs at the side opposite to the bottom wall portion. This enables the amplitude of the movable element to be increased while suppressing contact of the movable element with the bottom wall portion of the attachment member.

In an actuator of a fifth aspect, in the actuator of any one of the first aspect to the fourth aspect, an opening is formed at an elastic support, a portion of which is fixed to the attachment member and another portion of which is fixed to the moveable element.

According to the actuator of the fifth aspect, heat inside the actuator can be dissipated through the opening formed in the elastic support.

A vibration generating device of a sixth aspect includes: the actuator of any one of the first aspect to the fifth aspect; and a controller that controls a direction of current supplied to the coil, such that a maximum displacement amount of the moveable element from the origin position toward the side opposite to the bottom wall portion is greater than a maximum displacement amount of the moveable element from the origin position toward the bottom wall portion side.

According to the vibration generating device of the sixth aspect, the controller controls the direction of current supplied to the coil such that the maximum displacement amount of the movable element from the origin position toward the side opposite to the bottom wall portion is greater than the maximum displacement amount of the movable element from the origin position toward the bottom wall portion side. This enables the amplitude of the movable element to be increased while suppressing contact of the movable element with the bottom wall portion of the attachment member.

In a vibration generating device of a seventh aspect, in the vibration generating device of the sixth aspect, the controller controls the direction of the current supplied to the coil, so as to cause an initial movement of the moveable element to be displacement toward the bottom wall portion side.

According to the vibration generating device of a seventh aspect, the controller controls the direction of current supplied to the coil so as to cause the initial movement of the moveable element to be displacement toward the bottom wall portion side. Therefore, in a case in which short vibrations are generated in which vibrations of the movable element are amplified and damped, maximum displacement of the movable element occurs at the side opposite to the bottom wall portion. This enables the amplitude of the movable element to be increased while suppressing contact of the movable element with the bottom wall portion of the attachment member.

### Advantageous Effects of Invention

The actuator and the vibration generating device according to the present disclosure have advantageous effects of enabling the body size of the actuator to be reduced, and

### BRIEF DESCRIPTION OF THE DRAWINGS

FIG. 1 is a perspective view illustrating an actuator.

FIG. 2 is an exploded perspective view illustrating an actuator in an exploded manner.

FIG. 3 is a cross-sectional view illustrating a cross-section of an actuator taken along an X direction and a Z direction.

FIG. 4 is a perspective view illustrating an attachment member and the like in a state in which a coil is fixed.

FIG. 5 is a plan view illustrating an attachment member and the like in a state in which a coil is fixed.

FIG. 6 is a cross-sectional view illustrating an attachment member and the like in a state in which a coil is fixed, and illustrates a cross-section taken along an X direction and a Y direction at portions corresponding to a first communication hole and a second communication hole.

FIG. 7 is a cross-sectional perspective view illustrating an attachment member and the like, and illustrates a cross-section taken along an X direction and a Y direction at portions corresponding to a first communication hole and a second communication hole.

FIG. 8 is a block diagram illustrating a functional configuration of a controller.

FIG. 9 is a block diagram schematically illustrating a controller.

FIG. 10 is a flowchart illustrating control of a controller.

FIG. 11 is a graph illustrating a relationship between an intra-coil application voltage and time.

FIG. 12 is a diagram schematically illustrating a positional relationship between a movable element and an attachment member.

FIG. 13 is a graph illustrating a relationship between an intra-coil application voltage and time.

### DESCRIPTION OF EMBODIMENTS

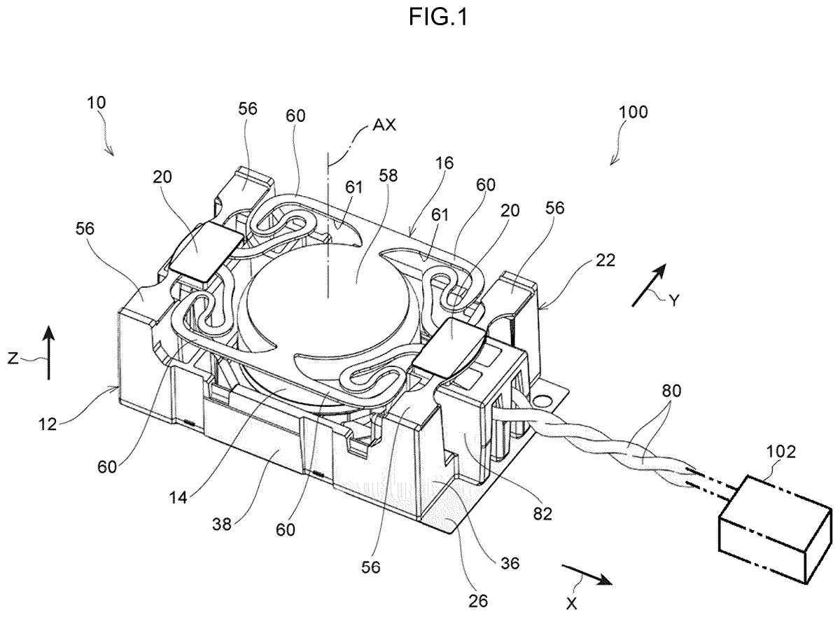

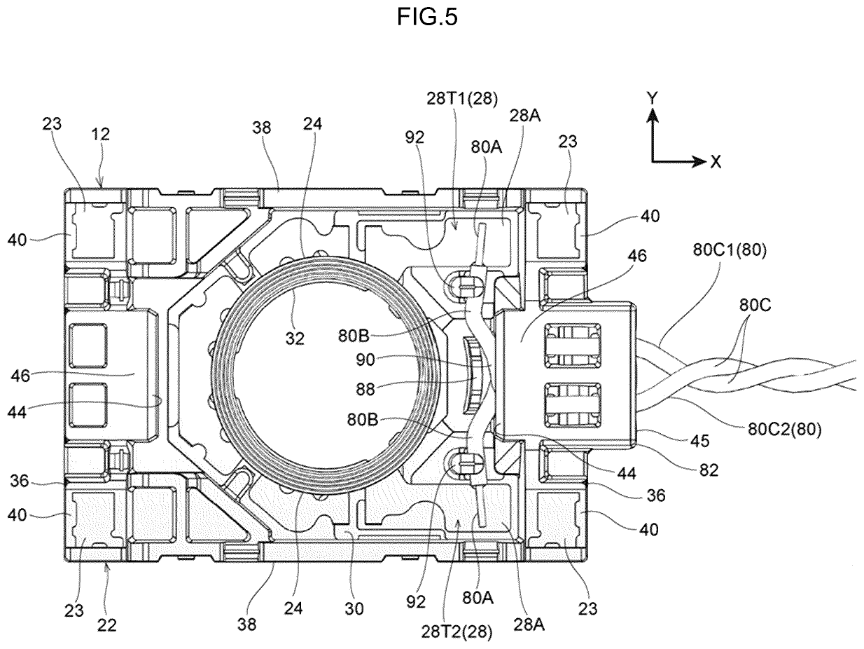

Explanation follows regarding a vibration generating device 100 according to an exemplary embodiment of the present disclosure, with reference to FIG. 1 to FIG. 9. As illustrated in FIG. 1, the vibration generating device 100 includes an actuator 10, and a controller 102 that controls the actuator 10. First, explanation follows regarding the actuator 10, and then explanation follows regarding the controller 102. Note that the arrow X direction, the arrow Y direction, and the arrow Z direction illustrated in the drawings indicate respective directions of the actuator 10. In the following explanation, a +Z direction and a −Z direction, which are illustrated in each of the drawings, are referred to as an upper direction and a lower direction, respectively. However, this is a directional concept based on the actuator, and does not limit the mounting position of the actuator. Further, an axis that is parallel to the Z direction and passes through a center of gravity of a movable element 14, which is described below, is referred to as a center of gravity axis AX of the movable element 14. Furthermore, a direction approaching the center of gravity axis AX of the movable element 14 in the X direction is referred to as an X direction inner side, a direction moving away from the center of gravity axis AX of the movable element 14 in the X direction is referred to as an X direction outer side, a direction approaching the center of gravity axis AX of the movable element 14 in the Y direction is referred to as a Y direction inner side, and a direction moving away from the center of gravity axis AX of the movable element 14 in the Y direction is referred to as a Y direction outer side. Moreover, a +X direction is referred to as one side in the X direction, a −X direction is referred to as another side in the X direction, a +Y direction is referred to as one side in the Y direction, a −Y direction is referred to as another side in the Y direction, a +Z direction is referred to as one side in the Z direction, and a −Z direction is referred to as another side in the Z direction.

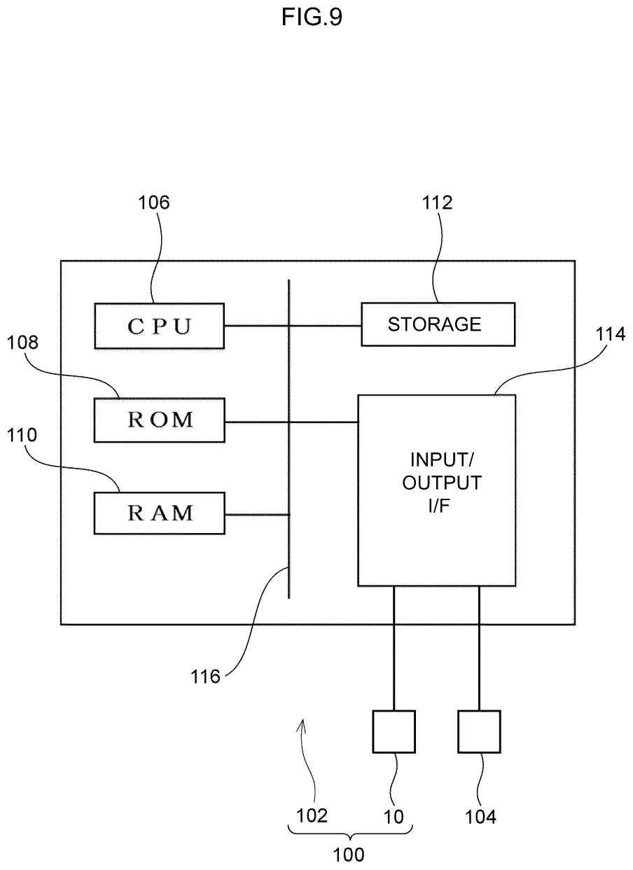

As illustrated in FIG. 1, the actuator 10 of the present exemplary embodiment is an actuator that is attached to a display such as a liquid crystal panel or the like configured as a touch panel, or a vibration target unit 104 (see FIG. 9) such as various controllers or the like, as an example, and thereby vibrates the display or the vibration target unit 104 such as a controller. By controlling the supply of current to the actuator 10, it is possible to impart various tactile sensations to a finger of a user touching the touch panel, the controller, or the like.

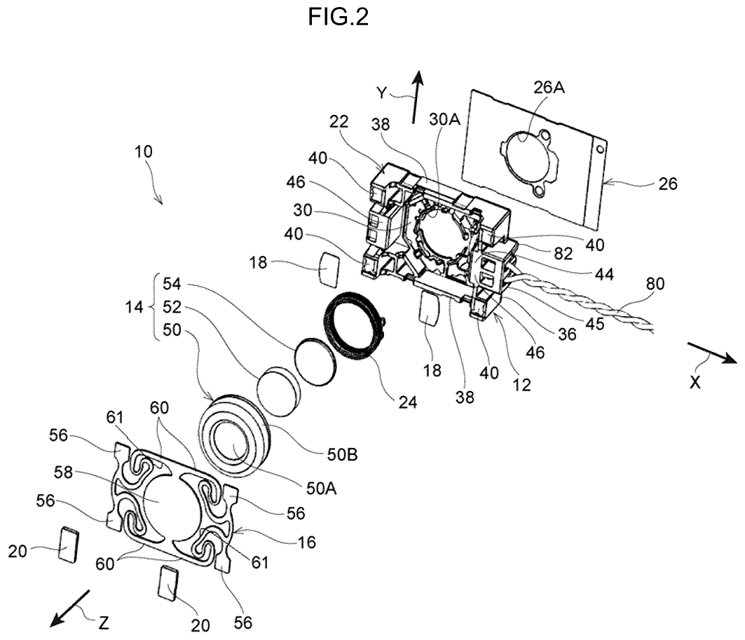

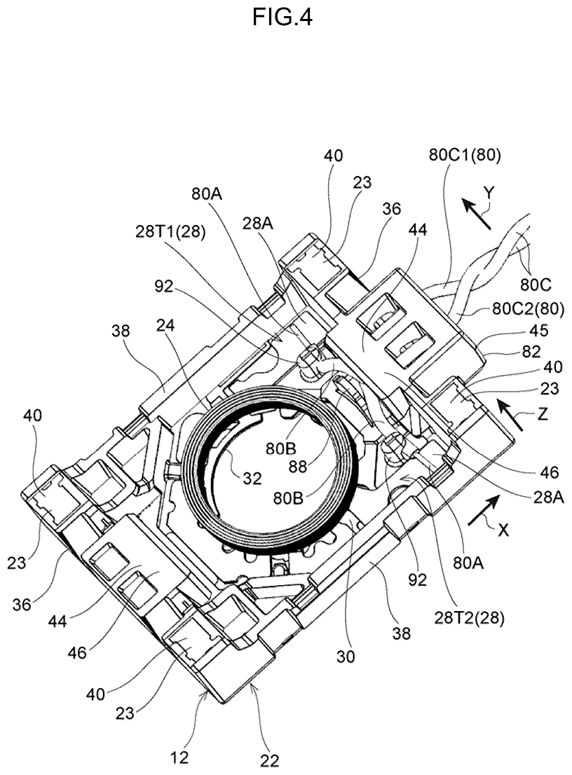

As illustrated in FIG. 1 and FIG. 2, the actuator 10 includes an attachment member 12 that is attached to an attachment target such as a display of a tablet terminal, a coil 24 that is fixed to the attachment member 12, the movable element 14 that is displaced with respect to the attachment member 12, and an elastic support 16 that elastically supports the movable element 14 with respect to the attachment member 12. The actuator 10 also includes two cushioning members 18 that damp vibration of the elastic support 16, and two cover members 20 that are attached to the elastic support 16 and that cover a surface at one side of the cushioning members 18. Further, as illustrated in FIG. 4, the actuator 10 includes a pair of terminals 28 and a pair of cables 80 for supplying current to the coil 24.

### Configuration of the Attachment Member 12

As illustrated in FIG. 1 to FIG. 6, the attachment member 12 includes a frame main body 22, which is formed in a box shape, and an attachment adhesive sheet 26. Note that the attachment member 12 is not limited to being formed in a box shape.

The frame main body 22, as an example, is formed using a resin material, and is formed in a box shape with one side, in the Z direction, open. Note that, the frame main body 22 is not limited to a resin material. The frame main body 22 includes a bottom wall portion 30 that is formed in a rectangular shape with a thickness direction in the Z direction, and as viewed from the Z direction, a longitudinal direction in the X direction and a lateral direction in the Y direction. As illustrated in FIG. 2 and FIG. 4, a circular opening 32 that penetrates in the Z direction is formed at a central portion in the X direction and the Y direction of the bottom wall portion 30.

The frame main body 22 includes a pair of first side wall portions 36 that respectively rise up toward the one side in the Z direction from an end portion, at the one side in the X direction, of the bottom wall portion 30, and from an end portion, at the other side in the X direction, of the bottom wall portion 30, and a pair of second side wall portions 38 that respectively rise us toward the one side in the Z direction from an end portion, at the one side in the Y direction, of the bottom wall portion 30, and from an end portion, at the other side in the Y direction, of the bottom wall portion 30.

As illustrated in FIG. 2, end portions at the one side in the Y direction and end portions at the other side in the Y direction at end faces, at the one side in Z direction side, of the pair of first side wall portions 36 are each a base portion 40. As illustrated in FIG. 4 to FIG. 7, in the attachment member 12 of the present exemplary embodiment, a metal frame 23 is fixed to the frame main body 22 by insert molding or the like. Most portion of the metal frame 23 is housed inside the frame main body 22. Further, portion of the metal frame 23 is exposed at an end face, at the one side in the Z direction, of each base portion 40.

The frame main body 22 includes a central projecting portion 44 that projects out from a central portion, in the Y direction, of one of the first side wall portions 36 toward another of the first side wall portions 36. Further, the frame main body 22 includes a central projecting portion 44 that projects out from a central portion, in the Y direction, of the other of first side wall portions 36 toward the one of the first side wall portions 36. Note that an end face, at the one side in the Z direction, of one central projecting portion 44 and a Y direction central portion at an end face, at the one side in the Z direction, of the one of the first side wall portions 36, are cushioning member attachment faces 46 to which one of the cushioning members 18, which are described later, is attached. Further, an end face, at the one side in the Z direction, of the other central projecting portion 44 and a Y direction central portion at an end face, at the one side in the Z direction, of the other of the first side wall portions 36 are cushioning member attachment faces 46 to which the other of the cushioning members 18, which are described later, is attached. Furthermore, the frame main body 22 includes a central outer side projecting portion 45 that projects out toward a frame main body outer side (one side in the X direction) from a central portion, in the Y direction, of the one (the one side in the X direction) of the first side wall portions 36.

### Configuration of the Coil 24

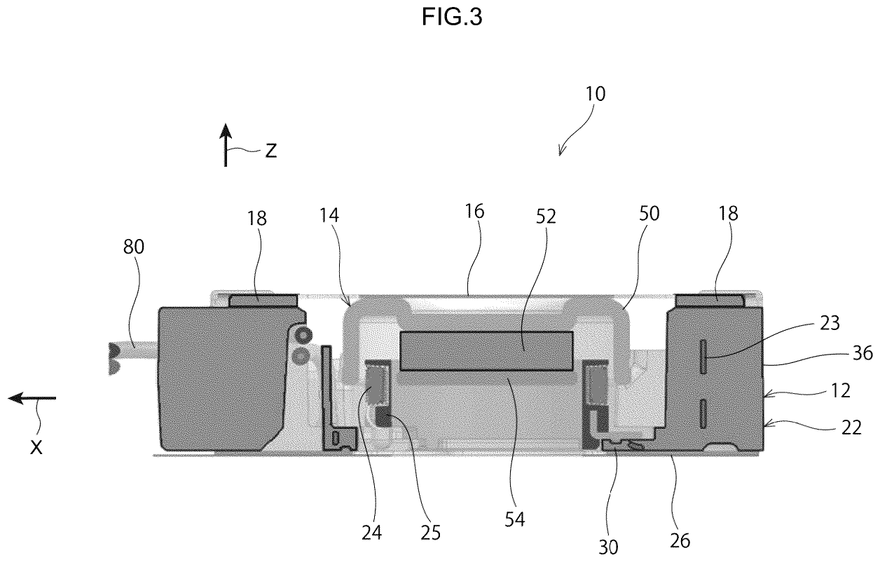

As illustrated in FIG. 2 to FIG. 6, the coil 24 is formed by winding an electrically conductive electric wire in an annular shape with the Z direction as an axial direction. As illustrated in FIG. 3, in the present exemplary embodiment, the coil 24 is formed around a bobbin 25 by winding an electrically conductive electric wire around the bobbin 25 that is formed in an annular shape. The coil 24 is supported by the bottom wall portion 30 of the frame main body 22 via the bobbin 25. Note that hatching of the cross-section is not illustrated in FIG. 3.

### Configuration of the Attachment Adhesive Sheet 26

As illustrated in FIG. 1 and FIG. 2, the attachment adhesive sheet 26 is a member for attaching the actuator 10 to an attachment target. The attachment adhesive sheet 26 is an adhesive sheet with both sides serving as adhesive surfaces. The attachment adhesive sheet 26 is adhered to a lower face side of the bottom wall portion 30 of the main frame main body 22. Note that a circular opening 26A, which corresponds to the opening 32 that is formed in the bottom wall portion 30 of the frame main body 22, is formed in the attachment adhesive sheet 26.

### Configuration of the Movable Element 14

The movable element 14 includes a yoke 50, a magnet 52, and a pole piece 54.

The yoke 50 is formed using a soft magnetic material. The yoke 50 includes a ceiling wall portion 50A that is formed in a disk shape with a thickness direction in the Z direction, and a peripheral wall portion 50B that extends downward from an outer side peripheral edge of the ceiling wall portion 50A.

The magnet 52 is formed in a disk shape with an axis direction along the Z direction. The magnet 52 is fixed to a lower face side of the ceiling wall portion 50A of the yoke 50 in a state of being disposed at an inner side of the peripheral wall portion 50B of the yoke 50.

The pole piece 54 is formed using a soft magnetic material. The pole piece 54 is formed in a disk shape with an axis direction along the Z direction, and is fixed to a lower face side of the magnet 52.

A magnetic circuit is formed by the yoke 50, the magnet 52, and the pole piece 54 in the movable element 14 as described above. A space is formed between the magnet 52 and the pole piece 54, and the peripheral wall portion 50B of the yoke 50, and the coil 24 is disposed in this space.

### Configuration of the Elastic Support 16

As illustrated in FIG. 1 and FIG. 2, the elastic support 16 is formed using, as an example, a metal plate that is formed in a plate shape (planar shape). The shape of the elastic support 16 in a free state (a state in which no external force is applied) is such that the entire elastic support 16 is formed in a plate shape along a direction orthogonal to the Z direction.

Portion of the elastic support 16 is fixed to the attachment member 12, and another portion of the elastic support is fixed to the movable element 14. A portion of the elastic support 16 between the portion fixed to the attachment member 12 and the portion fixed to the movable element 14 is a deforming portion 60, and the deforming portion 60 is a portion that is deformed when the movable element 14 is displaced (vibrates). More specifically, the elastic support 16 is configured with four attachment member side fixed portions 56 that are fixed to the attachment member 12, a movable element side fixed portion 58 that is fixed to the movable element 14, and four deforming portions 60 that connect the attachment member side fixed portions 56 and the movable element side fixed portion 58. In the present exemplary embodiment, dimensions and the like of the deforming portions 60 are set such that the displaceable amount of the movable element side fixed portion 58 toward a bottom wall portion 30 side with respect to the attachment member side fixed portions 56 is greater than a distance between the movable element 14 and the bottom wall portion 30.

The four attachment member side fixed portions 56 are formed in a rectangular shape, corresponding to the four base portions 40 of the frame main body 22, when viewed from the Z direction. The four attachment member side fixed portions 56 are each fixed to a portion of the metal frame 23 (see FIG. 4) exposed at the base portion 40 by welding or the like.

The movable element side fixed portion 58 is formed in a circular shape with a smaller diameter than the ceiling wall portion 50A of the yoke 50, which configures portion of the movable element 14, when viewed from the Z direction. The movable element side fixed portion 58 is fixed to the ceiling wall portion 50A of the yoke 50 by welding or the like.

Further, openings 61 are formed between the movable element side fixed portion 58 and the deforming portions 60 in the elastic support 16. This enables heat at an interior of the actuator 10 to be dissipated through the openings 61.

### Configuration of the Cushioning Members 18

As illustrated in FIG. 2, each cushioning member 18 is formed in a plate shape using a material having viscoelasticity, and is formed with a thickness direction in the Z direction and a rectangular shape when viewed from the Z direction. A face (lower face), at the other side in the Z direction, of each cushioning member 18 is an adhesive face that can be bonded to another member. Further, a face (upper face), at the one side in the Z direction, of each cushioning member 18 is an adhesive face that can be bonded to another member.

The adhesive face at a lower face side of one of the cushioning members 18 is attached to one of the cushioning member attachment faces 46 of the frame main body 22. Therefore, one of the cushioning members 18 is attached to one of the cushioning member attachment faces 46 of the frame main body 22. Similarly, the adhesive face at a lower face side of the other of the cushioning members 18 is attached to the other of the cushioning member attachment faces 46 of the frame main body 22. Therefore, the other of the cushioning members 18 is attached to the other of the cushioning member attachment faces 46 of the frame main body 22.

Note that in a state in which the elastic support 16 is attached to the frame main body 22, the adhesive face at an upper face side of the one of the cushioning members 18 is attached to a lower face side of a portion of a deforming portion 60 of the elastic support 16. In a similar manner, in a state in which the elastic support 16 is attached to the frame main body 22, the adhesive face at an upper face side of the other of the cushioning members 18 is attached to a lower face side of a portion of a deforming portion 60 of the elastic support 16.

### Configuration of the Cover Members 20

Each cover member 20 is formed in a plate shape using a material having viscoelasticity, and is formed with a thickness direction in the Z direction and a rectangular shape when viewed from the Z direction.

A face (lower face), at the other side in the Z direction, of each cover member 20 is an adhesive face that can be bonded to another member. Note that, a face (upper face), at the one side in the Z direction, of each cover member 20 is not a bonding face. An adhesive face at a lower face side of one of the cover members 20 is attached to the adhesive face at the upper face side of the one of the cushioning members 18 and an upper face side of portion of deforming portions 60 of the elastic support 16. In a similar manner, an adhesive face at a lower face side of the other of the cover members 20 is attached to the adhesive face at the upper face side of the other of the cushioning members 18 and an upper face side of portion of deforming portions 60 of the elastic support 16.

### Configuration of the Terminals 28

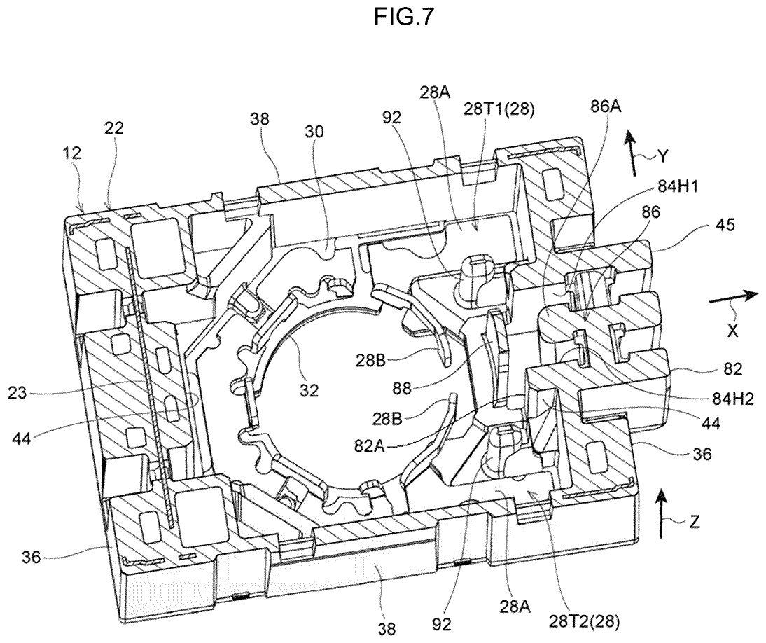

As illustrated in FIG. 7, the pair of terminals 28 are formed by, for example, folding conductive metal plates that have been cut into a predetermined shape. Note that one and another of the pair of terminals 28 are respectively referred to as a first terminal 28T1 and a second terminal 28T2.

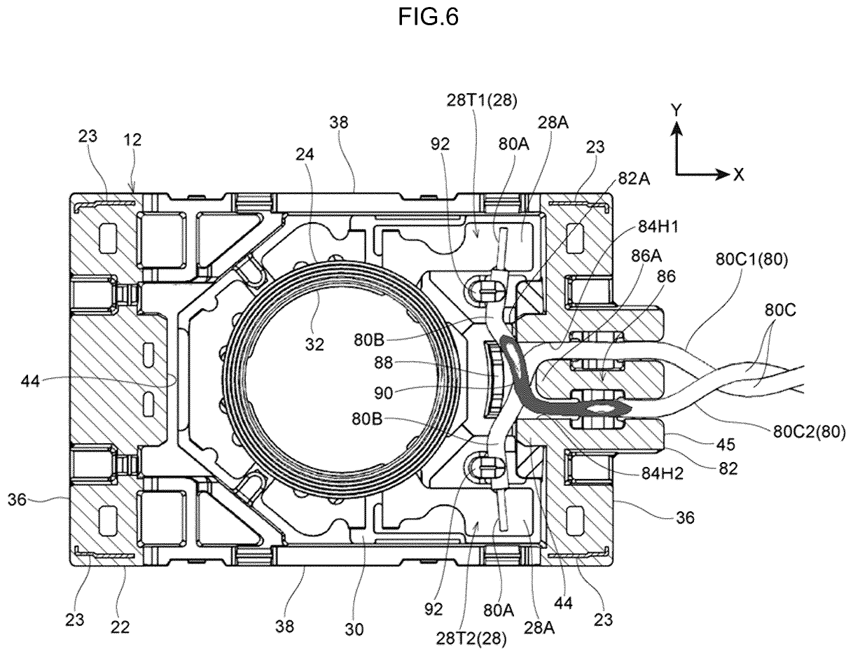

The first terminal 28T1 includes a cable joining portion 28A that, at the one side in the Y direction at the bottom wall portion 30 of the frame main body 22, extends from an intermediate portion, in the X direction, toward a first side wall portion 36 side at the one side in the X direction. Further, the first terminal 28T1 rises up toward the one side in the Z direction from an end portion, at the other side in the X direction, of the cable joining portion 28A, and includes a coil terminal joining portion 28B that extends toward the other side in the Y direction. The second terminal 28T2 includes a cable joining portion 28A that, at the other side in the Y direction at the bottom wall portion 30 of the frame main body 22, extends from an intermediate portion, in the X direction, toward the first side wall portion 36 side at the one side in the X direction. Further, the second terminal 28T2 rises up toward the one side in the Z direction from an end portion, at the other side in the X direction, of the cable joining portion 28A, and includes a coil terminal joining portion 28B that extends toward the one side in the Y direction. The cable joining portion 28A of the first terminal 28T1 and the cable joining portion 28A of the second terminal 28T2 are fixed to the bottom wall portion 30 of the frame main body 22. Further, end portions of the pair of cables 80 (see FIG. 6), which are described below, are respectively joined to the cable joining portion 28A of the first terminal 28T1 and the cable joining portion 28A of the second terminal 28T2 by soldering. Furthermore, a terminal at one side and a terminal at the other side of the above-described coil 24 (see FIG. 6) are respectively joined to the coil terminal joining portion 28B of the first terminal 28T1 and the coil terminal joining portion 28B of the second terminal 28T2.

### Detailed Configuration of the Frame Main Body 22

Next, explanation follows regarding a configuration of a portion in which the pair of cables 80, which are described below, are disposed in the frame main body 22.

As illustrated in FIG. 6 and FIG. 7, a central portion, in the Y direction, of the first side wall portion 36 at the one side in the X direction, the central projecting portion 44, and the central outer side projecting portion 45 of the frame body 22 are a cable insertion portion 82 into which the pair of cables 80 are inserted. A first communication hole 84H1 and a second communication hole 84H2 which communicate between the inside and the outside of the frame main body 22 are formed in the cable insertion portion 82. The first communication hole 84H1 and the second communication hole 84H2 are formed side-by-side in the Y direction. Note that the first communication hole 84H1 is disposed at the one side in the Y direction with respect to the second communication hole 84H2.

As illustrated in FIG. 6 and FIG. 7, in the cable insertion portion 82, a portion that separates the first communication hole 84H1 and the second communication hole 84H2 in the Y direction is a first partition wall portion 86. The shape of an end portion 86A, at an inner side of the frame main body 22, of the first partition wall portion 86 is such that both end portions in the Y direction are curved, when viewed from the Z direction. In addition thereto, the end portion 86A, at the inner side of the frame main body 22, of the first partition wall portion 86 is positioned at the one side in the X direction with respect to an end face 82A, at the other side in the X direction, of the cable insertion portion 82. Further, the end portion 86A, at the inner side of the frame main body 22, of the first partition wall portion 86 is positioned at the one side in the X direction with respect to a portion of the pair of cables 80, which is described below, that is fixed to the first terminal 28T1 and the second terminal 28T2 by soldering.

The frame main body 22 includes a second partition wall portion 88 that projects out toward the one side in the Z direction from the bottom wall portion 30. The second partition wall portion 88 functions as a portion that separates, in the X direction, the side at which the movable element 14 is disposed at the interior of the frame main body 22 from the side at which an intersecting portion of the cable 80 that is inserted into the first communication hole 84H1 and the cable 80 that is inserted into the second communication hole 84H2 is disposed. More specifically, the second partition wall portion 88 is formed in a tongue shape that extends in the Y direction and the Z direction, with the X direction as a thickness direction. Further, the second partition wall portion 88 is disposed at a central portion in the Y direction, and is disposed facing the cable insertion portion 82 in the X direction.

The frame main body 22 includes a pair of positioning portions 92 that project out toward the one side in the Z direction from the bottom wall portion 30. The pair of positioning portions 92 function as portions that perform positioning of the pair of cables 80 at the interior of the frame main body 22. More specifically, one of the positioning portions 92 is disposed at the one side in the Y direction with respect to the second partition wall portion 88, and at the other side in the Y direction with respect to the cable joining portion 28A of the first terminal 28T1. Further, the other of the positioning portions 92 is disposed at the other side in the Y direction with respect to the second partition wall portion 88, and at the one side in the Y direction with respect to the cable joining portion 28A of the second terminal 28T2. End portions, at the one side in the Z direction, of the pair of positioning portions 92 project out toward the one side in the X direction with respect to end portions, at the other side in the Z direction, of the pair of positioning portions 92.

### Configuration of the Cables 80

As illustrated in FIG. 6, as an example, the pair of cables 80 have a configuration in which a conductive member, such as a copper wire or the like, is covered with a covering member having insulating properties. Note that, respective portions of the pair of cables 80 that are joined to the cable joining portion 28A of the first terminal 28T1 and the cable joining portion 28A of the second terminal 28T2 by soldering are referred to as solder joining portions 80A. At the solder joining portions 80A, the covering member is removed. Note that one and the other of the pair of cables 80 are referred to as a first cable 80C1 and a second cable 80C2, respectively.

As illustrated in FIG. 6, the first cable 80C1 is inserted into the interior of the frame main body 22 through the first communication hole 84H1 that is formed in the cable insertion portion 82. A portion 80B of the first cable 80C1 which is disposed at the interior of the frame main body 22 is bent toward the other side in the Y direction along the end portion 86A of the first partition wall portion 86 at the inner side of the frame main body 22. Further, a portion of the first cable 80C1, which is in a state disposed at the one side in the X direction with respect to the positioning portion 92 at the other side in the Y direction, contacts the aforementioned positioning portion 92. Therefore, a state in which the solder joining portion 80A of the first cable 80C1 is positioned on the cable joining portion 28A of the second terminal 28T2 is maintained. Further, the solder joining portion 80A of the first cable 80C1 is joined (fixed) to the cable joining portion 28A of the second terminal 28T2 by solder, not illustrated in the drawings.

The second cable 80C2 is inserted into the interior of the frame main body 22 through the second communication hole 84H2 that is formed in the cable insertion portion 82. A portion 80B of the second cable 80C2 which is disposed at the interior of the frame main body 22 is bent toward the one side in the Y direction along the end portion 86A of the first partition wall 86 at the inner side of the frame main body 22. Further, a portion of the second cable 80C2, which is in a state disposed at the one side in the X direction with respect to the positioning portion 92 at the one side in the Y direction, contacts the aforementioned positioning portion 92. Therefore, a state in which the solder joining portion 80A of the second cable 80C2 is positioned on the cable joining portion 28A of the first terminal 28T1 is maintained. Further, the solder joining portion 80A of the second cable 80C2 is joined (fixed) to the cable joining portion 28A of the first terminal 28T1 by solder, not illustrated in the drawings.

The portion 80B of the first cable 80C1 which is disposed at the interior of the frame main body 22 and the portion 80B of the second cable 80C2 which is disposed at the interior of the frame main body 22 intersect in an area adjacent to the end portion 86A, at the inner side of the frame main body 22 at the first partition wall portion 86, when viewed from the one side in the Z direction. Note that a portion at which the first cable 80C1 and the second cable 80C2 intersect with each other when viewed from the one side in the Z direction is referred to as an intersecting portion 90. At the intersecting portion 90 between the first cable 80C1 and the second cable 80C2, the second cable 80C2 is disposed at the one side in the Z direction with respect to the first cable 80C1.

A portion 80C of the first cable 80C1 which is disposed at an outer side of the frame main body 22, and a portion 80C of the second cable 80C2 which is disposed at the outside side of the frame main body 22 are in a state pulled out toward the one side in the X direction from the frame main body 22. The portion 80C of the first cable 80C1 which is disposed at the outer side of the frame main body 22 and the portion 80C of the second cable 80C2 which is disposed at the outer side of the frame main body 22 are twisted in a spiral shape with respect to each other. Therefore, the portion 80C of the first cable 80C1 which is disposed at the outer side of the frame main body 22 and the portion 80C of the second cable 80C2 which is disposed at the outer side of the frame main body 22 are less likely to be separated from each other.

### Configuration of the Controller 102

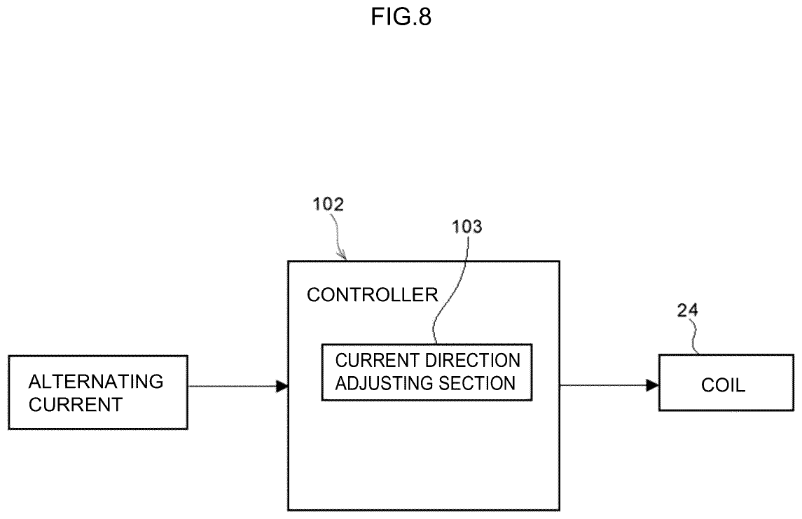

As illustrated in FIG. 8, the controller 102 functions as a current direction adjusting section 103 that adjusts a current direction of the input alternating current and supplies current to the coil 24. As illustrated in FIG. 9, the controller 102 includes, as an example, a central processing unit (CPU; serving as a processor) 106, read only memory (ROM) 108, random access memory (RAM) 110, storage 112, and an input/output interface (I/F) 114 that performs communication with external devices, and these respective configurations are communicably connected to each other via a bus 116.

The actuator 10, the display such as a liquid crystal panel, and the vibration target unit 104 of various controllers or the like are electrically connected to the input/output interface 114. The CPU 106 is a central processing unit, and executes various programs to control vibration of the actuator 10. More specifically, based on signals from the vibration target unit 104, the CPU 106 reads a control program from the ROM 108 or the storage 112, executes the control program using the RAM 110 as a workspace, and controls vibration of the actuator 10. Therefore, vibration of the actuator 10 is controlled, and vibration of the vibration target unit 104 to which the actuator 10 is attached is controlled.

### Operation and Effects of the Present Exemplary Embodiment

Next, explanation follows regarding operation and effects of the present exemplary embodiment.

As illustrated in FIG. 1 to FIG. 6, in the actuator 10 described above, the movable element 14 is supported by the elastic support 16, and in a state in which no current is supplied to the coil 24, the movable element 14 is in the origin position illustrated in FIG. 1. In the actuator 10 of the present exemplary embodiment, the configuration is such that the coil 24 is fixed to the frame main body 22, and the magnet 52 and the like are provided at the movable element 14. Therefore, when current is supplied to the coil 24 via the first cable 80C1 and the second cable 80C2, and the first terminal 28T1 and the second terminal 28T2, a thrust, serving as a reaction force of a force generated from the coil 24, is generated at the movable element 14. An alternating current or the like is supplied to the coil 24, such that the movable element 14 vibrates in an up-down direction along the center of gravity axis AX. Note that a direction in which the current is supplied refers to the direction of current flowing through the coil 24.

Note that a voltage that is applied between the coil 24 is referred to as an intra-coil application voltage V_{C}. Further, in a state in which the value of the intra-coil application voltage V_{C} is a positive value, current is supplied to the coil 24 in one direction. In contrast, in a state in which the value of the intra-coil applied voltage V_{C} is a negative value, current is supplied to the coil 24 in the other direction. Note that, the state in which the value of the intra-coil application voltage V_{C} is a positive value refers to a state in which the potential of the second terminal 28T2 is higher than the potential of the first terminal 28T1. Further, the state in which the value of the intra-coil application voltage V_{C} is a negative value refers to a state in which the potential of the first terminal 28T1 is higher than the potential of the second terminal 28T2.

When current is supplied to the coil 24 in one direction due to the value of the intra-coil application voltage V_{C} being a positive value, a thrust toward the one side in the Z direction is generated at the movable element 14. When this occurs, the movable element 14 is displaced so as to jut out from the attachment member 22. In other words, the movable element 14 is displaced beyond the end portion, at the side opposite to the bottom wall portion 36, of the attachment member 22, in the vibration direction of the movable element 14. Further, when current is supplied to the coil 24 in the other direction due to the value of the intra-coil application voltage V_{C} being a negative value, a thrust toward the other side in the Z direction is generated at the movable element 14.

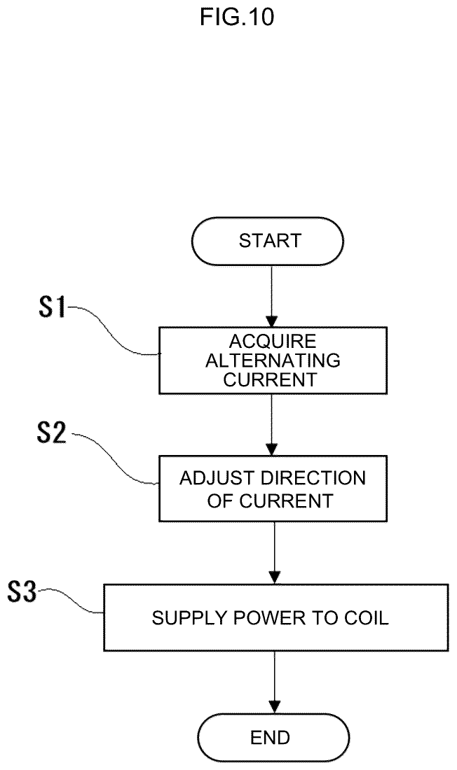

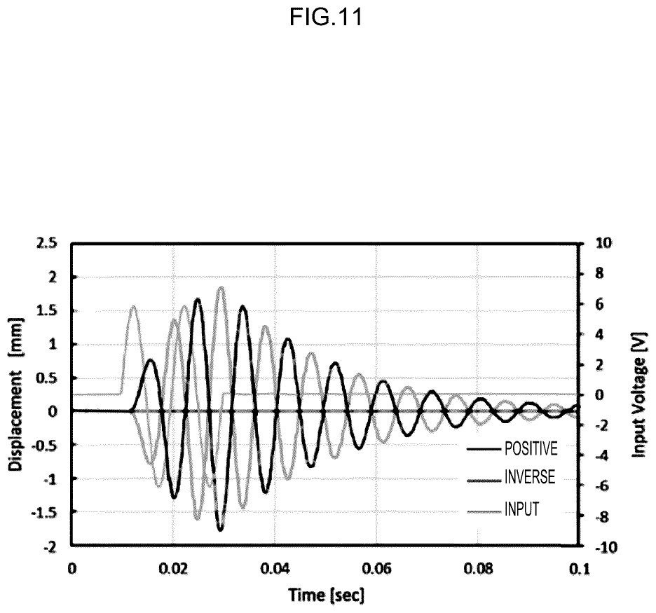

When the controller 102 detects that the user has contacted the vibration target unit 104 due to the user operating the vibration target unit 104, for example, the controller 102 acquires an alternating current at step S1, as illustrated in FIG. 10. Next, at step S2, the controller 102 adjusts the direction of the alternating current acquired at step S1, and supplies power to the coil 24 at step S3. Namely, the controller 102 applies the intra-coil application voltage V_{C} (Input Voltage in FIG. 11) between the coil 24, as indicated by “Input” in FIG. 11, and starts supplying current to the coil 24.

Note that, “Displacement [mm]” in FIG. 11 is a displacement amount of the movable element 14 from an origin position S, a positive value indicates a displacement amount toward a side opposite to the bottom wall portion 30, and a negative value indicates a displacement amount toward a bottom wall portion 30 side. When starting to supply current to the coil 24, the controller 102 starts to supply current to the coil 24 in one direction by applying a voltage between the coil 24 in a waveform indicated by “inverse” in FIG. 11. Therefore, a thrust toward the one side in the Z direction is first generated at the movable element 14. Note that in FIG. 11, the waveforms indicated by “positive” and “inverse” are sine waves that are amplified and then attenuated over time. Note that the vibration of the movable element 14 which is assumed in the present exemplary embodiment is vibration that causes short vibration (for example, two pulses of vibration) to be generated at the vibration target unit 104.

In FIG. 11, in a case in which an intra-coil application voltage V_{C} having waveforms indicated by “positive” and “inverse” is applied between the coil 24, the displacement amount of the movable element 14 in the first pulse directly after the movable element 14 starts to move is small, and the displacement amount of the movable element 14 gradually increases. Thereafter, the displacement amount of the movable element 14 gradually decreases. The maximum displacement amount of a rising portion in which the displacement amount of the movable element 14 gradually increases differs between a case in which the intra-coil application voltage V_{C} with a waveform indicated by “positive” in FIG. 11 is applied between the coil 24, and a case in which the intra-coil application voltage V_{C} with a waveform indicated by “inverse” in FIG. 11 is applied between the coil 24. Namely, in FIG. 11, in a case in which an intra-coil application voltage V_{C} with a waveform indicated by “inverse” is applied between the coil 24, a portion that becomes the maximum displacement amount of a rising portion in which the displacement amount of the movable element 14 gradually increases occurs when the movable element 14 has been displaced toward a side opposite to the bottom wall portion 30. On the other hand, in a case in which an intra-coil application voltage V_{C} with a waveform indicated as “positive” in FIG. 11 is applied between the coil 24, a portion that becomes the maximum displacement amount of a rising portion in which the displacement amount of the movable element 14 gradually increases occurs when the movable element 14 has been displaced toward the bottom wall portion 30 side.

Therefore, in the present exemplary embodiment, the controller 102 controls the direction of current to the coil 24, and applies an intra-coil application voltage V_{C} with a waveform indicated by “inverse” between the coil 24, such that a portion that becomes the maximum displacement amount of a rising portion in which the displacement amount of the movable element 14 gradually increases is formed when the movable element 14 has been displaced toward the side opposite to the bottom wall portion 30, thereby suppressing interference between the movable element 14 and the bottom wall portion 30.

In other words, the current direction adjusting section 103 controls the direction of current to the coil 24 such that the maximum displacement of the movable element 14 is at the side opposite to the bottom wall portion 30. The controller 102 controls the direction of the current supplied to the coil 24 such that the maximum displacement amount of the movable element 14 from the origin position toward the side opposite to the bottom wall portion 30 is greater than the maximum displacement amount of the movable element 14 from the origin position toward the bottom wall portion 30 side. The controller 102 controls the direction of the current supplied to the coil 24 so as to displace the initial movement of the movable element 14 toward the bottom wall portion 30 side. Namely, the movable element 14 is configured to be displaced toward the bottom wall portion 30 side in an initial movement when current is supplied to the coil 24.

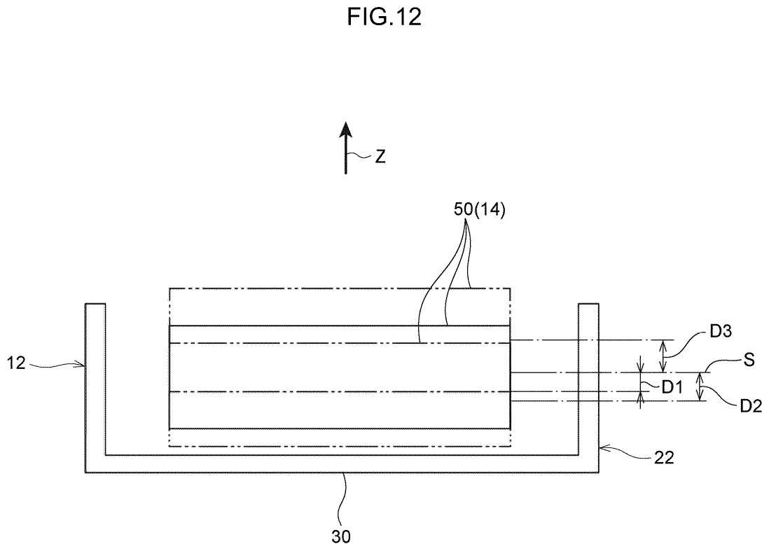

Namely, as illustrated in FIG. 12, in the present exemplary embodiment, the controller 102 controls the supply of current to the coil 24 such that a displacement amount D1 of the movable element 14 from the origin position S toward the bottom wall portion 30 side (the other side in the Z direction) is less than a specified displacement amount D2. Note that the specified displacement amount D2 is a displacement amount by which the movable element 14 starts to contact the bottom wall portion 30 when the movable element 14 has been displaced from the origin position S toward the bottom wall portion 30 side.

As explained above, in the vibration generating device 100 including the actuator 10 and the controller 102 of the present exemplary embodiment, and the controller 102 controls the supply of current to the coil 24 such that the displacement amount D1 of the movable element 14 from the origin position S toward the bottom wall portion 30 side is less than the predetermined displacement amount D2. This enables the movable element 14 to be inhibited from contacting the attachment member 12 (the bottom wall portion 30 of the frame main body 22).

In the present exemplary embodiment, when the controller 102 applies the intra-coil application voltage V_{C} between the coil 24 so as to have the frequencies of the waveforms illustrated in FIG. 11, a displacement amount D3 of the movable element 14 from the origin position S toward the side opposite to the bottom wall portion (the one side in the Z direction) is greater than the displacement amount D1 of the movable element 14 from the origin position S toward the bottom wall portion 30 side. This is realized due to the controller 102 starting to supply current to the coil 24 in one direction when the controller 102 starts to supply current to the coil 24. Therefore, in the present exemplary embodiment, contact of the movable element 14 with the attachment member 12 can be suppressed while securing a displacement amount of the movable element 14 in the Z direction. Further, in the present exemplary embodiment, even if a maximum value V_{C1} of the absolute value of the voltage that is applied to the coil 24 when current is supplied in one direction to the coil 24 and a maximum value V_{C1} of the absolute value of the voltage applied to the coil 24 when current is supplied in the other direction to the coil 24 are the same values, it is possible to suppress the movable element 14 from contacting the attachment member 12.

Note that, in the present exemplary embodiment, an example has been described in which the maximum value V_{C1} of the absolute value of the voltage that is applied to the coil 24 when current is supplied in one direction to the coil 24 and the maximum value V_{C1} of the absolute value of the voltage applied to the coil 24 when current is supplied in the other direction to the coil 24 are the same values; however, the present disclosure is not limited thereto. For example, the absolute value of the voltage applied to the coil 24 may be varied.

Further, in the present exemplary embodiment, explanation has been made regarding an example in which the controller 102 starts to supply current to the coil 24 in one direction when the controller 102 starts to supply current to the coil 24; however, the present disclosure is not limited thereto. For example, when the controller 102 starts to supply current to the coil 24, the controller 102 may start to supply current in the other direction.

Furthermore, in the present exemplary embodiment, explanation has been made regarding an example in which the displacement amount D3 of the movable element 14 from the origin position S toward the side opposite to the bottom wall portion 30 (the one side in the Z direction one) is greater than the displacement amount D1 of the movable element 14 from the origin position S toward the bottom wall portion 30 side; however, the present disclosure is not limited thereto. For example, the displacement amount D3 of the movable element 14 from the origin position S toward the side opposite to the bottom wall portion 30 (the one side in the Z direction), and the displacement amount D1 of the movable element 14 from the origin position S toward the bottom wall portion 30 side may be the same displacement amount.

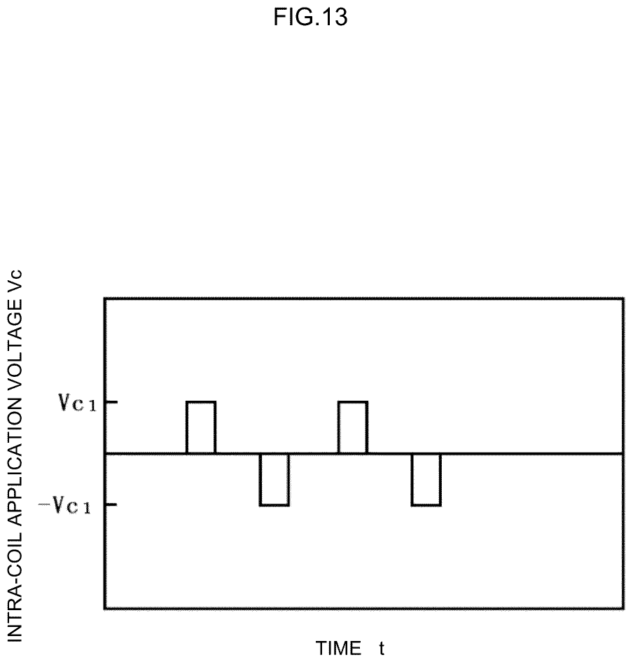

In the present exemplary embodiment, an example in which the intra-coil application voltage V_{C} is a sine wave has been described; however, the present disclosure is not limited thereto. As illustrated in FIG. 13, for example, the intra-coil application voltage V_{C} may be a pulse wave.

Further, in the present exemplary embodiment, an example in which the elastic support 16 is formed using a metal plate has been described. However, the elastic support is not limited to being made of metal, and may be made of a resin (including an elastomer) or cloth. Furthermore, the elastic support is not limited to a plate shape.

Although an exemplary embodiment of the present disclosure has been explained above, the present disclosure is not limited to the above, and obviously various modifications other than the above can be implemented within a range that does not depart from the gist of the present disclosure.

The disclosure of Japanese Patent Application No. 2022-178975, filed Nov. 8, 2022, is hereby incorporated by reference in its entirety.

1. An actuator, comprising:
an attachment member including a bottom wall portion, the attachment member being open at a side opposite to the bottom wall portion;
a coil disposed at an inner side of the attachment member, the coil being fixed to the attachment member; and
a moveable element including a magnet disposed opposite to the coil, the moveable element being positioned at an origin position in a state in which current is not supplied to the coil, the moveable element displacing toward a bottom wall portion side due to current being supplied to the coil in one direction, and displacing toward the side opposite to the bottom wall portion due to current being supplied to the coil in another direction,
wherein the moveable element is displaceable so as to jut out from the attachment member when the moveable element is displaced toward the side opposite to the bottom wall portion.

2. The actuator according to claim 1, wherein a displacement amount of the moveable element toward the side opposite to the bottom wall portion is greater than a displacement amount of the moveable element toward the bottom wall portion side.

3. The actuator according to claim 1, wherein a displaceable amount of an elastic support, a portion of which is fixed to the attachment member and another portion of which is fixed to the moveable element, toward the bottom wall portion side is greater than a distance between the moveable element and the bottom wall portion.

4. The actuator according to claim 1, wherein an initial movement of the moveable element, when current is supplied to the coil, is displacement toward the bottom wall portion side.

5. The actuator according to claim 1, wherein an opening is formed at an elastic support, a portion of which is fixed to the attachment member and another portion of which is fixed to the moveable element.

6. A vibration generating device, comprising:
the actuator according to claim 1; and
a controller that controls a direction of current supplied to the coil, such that a maximum displacement amount of the moveable element from the origin position toward the side opposite to the bottom wall portion is greater than a maximum displacement amount of the moveable element from the origin position toward the bottom wall portion side.

7. The vibration generating device according to claim 6, wherein the controller controls the direction of the current supplied to the coil, so as to cause an initial movement of the moveable element to be displacement toward the bottom wall portion side.
